(19) United States
(12) Patent Application Publication
(10) Pub. No.: US 2026/0357651 A1
(43) Pub. Date: Nov. 12, 2026

(54) INTEGRATED MAGNETIC SCREEN SYSTEM WITH OPTIONAL ZIPPER BUILT INTO SLIDING SCREEN DOOR FRAME

(71) Applicant: Marc Tessier, Bedford, NH (US)

(72) Inventor: Marc Tessier, Bedford, NH (US)

(21) Appl. No.: 19/246,620

(22) Filed: Jun. 23, 2025

Related U.S. Application Data
(63) Continuation-in-part of application No. 19/205,826, filed on May 12, 2025.

(51) Int. Cl. E06B 9/52; E05C 19/16

(52) U.S. Cl. CPC E06B 9/52; E05C 19/16

(57) ABSTRACT

An integrated magnetic screen system is designed for a sliding screen door frame. The system includes a mesh screen with vertical and horizontal cut regions that allow users to pass through and automatically reseal using vertical magnetic strips. The mesh may also include an upper cut region, which can be V-shaped, U-shaped, trapezoidal, or linear, intersected by a horizontal bridge for added structure. Magnetic strips may be positioned along the seams and bridge to support resealing. Optional zippers may be placed along the vertical and bottom portions of the mesh for manual closure. The screen may include reinforced corners for durability and operate independently of the sliding glass door. The system can be factory-installed or offered as a retrofit kit and fits standard or custom sliding door frames.

### CROSS-REFERENCE TO RELATED APPLICATIONS

This application claims the benefit of U.S. Provisional Patent Application No. 63/803,651, filed on May 10, 2025, the entire contents of which are incorporated herein by reference.

### BACKGROUND OF THE INVENTION

Traditional screen doors require manual operation and do not offer convenient hand-free use. Aftermarket mesh screen products are widely available but are often low-quality, externally attached, and lack true integration with the door frame. These temporary solutions tend to fall short in terms of durability, appearance, and ease of use, and they may not include optional features for added functionality.

There exists a need for a more permanent, reliable, and visually unobtrusive magnetic screen system that enables hands-free entry and automatic resealing. A solution built directly into the screen door frame, optionally including zippers or other mechanisms, would enhance usability while maintaining airflow and insect protection.

### SUMMARY OF THE INVENTION

The invention described herein is a walk-through mesh screen system integrated into the frame of a sliding screen door. Unlike temporary mesh curtain products, this system is intended as a permanent, factory-installed or aftermarket upgrade. The mesh screen (12) includes a vertical cut region (25) and a horizontal cut region (26) that allow it to part during use and automatically reseal afterward via aligned vertical magnetic strips (24) and optional aligned horizontal magnetic strips (18). The vertical cut region (25) may be positioned anywhere within the mesh screen to create a hand-free opening that self-closes after passage. The horizontal cut region (26), located near the bottom of the mesh screen, enables additional flexibility and separation of the mesh for full entry and exit.

In certain embodiments, optional zippers (22, 32) may be installed alongside the vertical and/or horizontal cut regions (25, 26) to allow manual sealing when desired. This feature adds versatility by enabling the screen to function as a more rigid, non-walk-through barrier, particularly useful in households with children or pets. The screen system operates independently of the sliding door mechanism and does not interfere with the door's normal movement, preserving full functionality of the sliding door.

A distinguishing feature of the invention is the inclusion of an upper cut region (16) formed in the mesh screen (12), which may include one or more angled or shaped cuts extending from or intersecting with the top portion of the vertical cut region (25). These upper cuts may take the form of a V, U, trapezoid, straight slit, or other geometries, and may be symmetrical or asymmetrical. In some embodiments, the cut region may include a horizontal bridge (17) spanning between opposing cut edges to maintain structural alignment and support smoother screen opening and resealing. Optional magnetic strips (10) may be included along the cut edges and/or across the bridge (17) to assist with automatic self-closing.

Additional optional features include reinforced lower mesh corners (30) for increased durability at high-stress points, optional bottom magnetic strips (18) to help secure the mesh in the closed position, and optional bottom zippers (32) for a more rigid sealing near the bottom opening. The screen system is supported by a sliding screen door frame (14), compatible with standard sliding door tracks, and can be manufactured for both OEM integration and aftermarket installation.

This invention addresses the common homeowner's need for a durable, hands-free, visually integrated, and resealable screen door system. By enabling entry through vertical and horizontal cut regions within the sliding screen door that automatically align and reseal, the invention provides a significant improvement over removable mesh attachments or unmodified screen panels.

### BRIEF DESCRIPTION OF THE DRAWINGS

FIG. 1 illustrates the system as integrated into a sliding screen door frame.

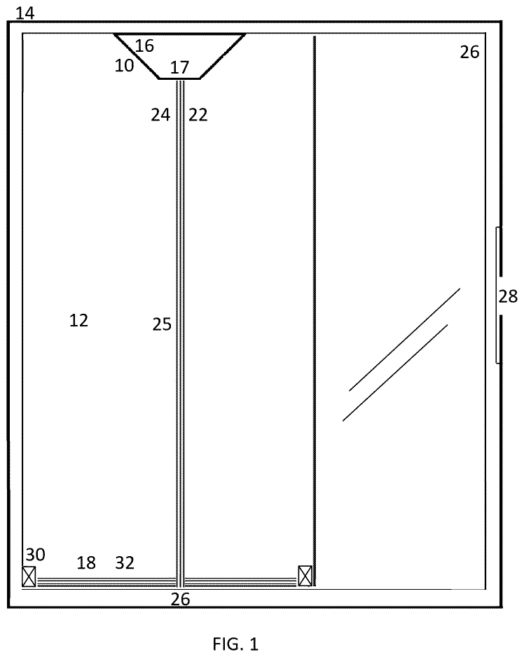

The mesh screen (12) may be formed as a single unbroken mesh panel or as multiple mesh segments, supported by the sliding screen door frame (14). It includes functional openings, such as a vertically cut region (25), a horizontal bottom cut region (26), and in some embodiments, one or more upper cut regions (16), which may be V-shaped or formed in other shapes, optionally intersected by a horizontal bridge (17). These strategically positioned cut regions allow the screen to open wider during passage and also preserve structural continuity in the surrounding mesh.

Magnetic strips (24) are positioned vertically along the vertical cut region (25), and optional components include bottom magnetic strips (18), zippers (22, 32), and reinforced lower mesh corners (30), which together enhance alignment, durability, and usability.

The sliding screen door (14) continues to slide as originally designed, and the adjacent glass sliding door (28) remains unaffected.

### DETAILED DESCRIPTION OF THE INVENTION

The present invention provides an integrated magnetic screen system built into a sliding screen door frame (14), enabling hand-free entry and automatic resealing while maintaining airflow and insect protection. The invention is designed to be compatible with existing sliding glass door systems and can be implemented as either a factory-installed (OEM) solution or an aftermarket upgrade.

### Mesh Screen Structure

The mesh screen (12) may be formed as a single unbroken panel or as multiple mesh segments that function together within the door frame. The screen incorporates strategically placed cut regions that allow the mesh to part for walk-through access and return to a sealed state after passage.

A vertical cut region (25) is positioned along the mesh screen (12), creating a central or offset opening to permit entry. This vertical seam is held together by magnetic strips (24), which are permanently affixed along both sides of the vertical opening to enable automatic closure after the user passes through. The magnetic connection maintains contact along the full height of the opening while allowing flexible separation under gentle pressure.

A horizontal bottom cut region (26) extends across the lower portion and is elevated slightly from the bottom edge of the mesh screen (12), allowing the screen to separate along both vertical and horizontal axes. This configuration enhances flexibility and ease of entry, particularly for users carrying items, children, or pets. The lower cut region may stop short of the screen's lateral edges, preserving structural integrity along the perimeter.

In certain embodiments, zippers (22, 32) may be installed along either the vertical or horizontal cut regions (25, 26). These optional zippers enable manual sealing of the mesh when desired, converting the walk-through screen into a temporarily fixed barrier. This may be beneficial in situations where additional containment is needed, such as when preventing pets from exiting or during high wind conditions.

### Upper Cut Region

A distinguishing feature of the invention is the presence of an upper cut region (16), positioned near the top portion of the mesh screen. In some embodiments, this region includes symmetrical or asymmetrical shapes such as a V, U, straight slit, or other geometries extending from one or both sides of the vertical cut region (25). These upper cut regions improve the screen's flexibility and allow for a wider or more ergonomic opening during use.

Optionally, a horizontal bridge (17) may span across the bottom of the upper cut region (16) to preserve structural alignment between opposing mesh sections. This bridge may be stitched, heat-sealed, or formed using reinforced mesh or synthetic webbing. In select implementations, optional magnetic strips (10) may be placed along the angled or vertical seams of the upper cut region (16) and/or across the horizontal bridge (17) to enhance sealing performance after use.

### Structural Components and Reinforcements

The screen is supported by the sliding screen door frame (14), which continues to operate in its original sliding track. The invention is designed so that it does not interfere with the normal motion of the adjacent glass sliding door (28), allowing the glass panel to function as originally intended.

To improve durability, reinforced lower mesh corners (30) may be included where the vertical and horizontal cut regions converge. These reinforcements may be formed from any durable material or structural treatment suitable for reducing strain at high-stress points, including but not limited to layered mesh, sewn backing, synthetic patches, fabric composites, or flexible reinforcement elements.

The bottom edge of the mesh screen may also include optional magnetic strips (18) to assist with closure and maintain alignment near the bottom portion of the screen. These may help draw the mesh toward the door sill area without requiring direct attachment to the frame. Bottom zippers (32) may be included as an optional or supplemental closure mechanism, either in conjunction with or as an alternative to bottom magnetic strips (18), allowing manual closure of the lower portion of the screen when desired.

### Manufacturing and Installation

The system may be manufactured as a fully integrated sliding screen door assembly or offered as a retrofit kit compatible with standard or custom sliding door dimensions. In all configurations, the mesh screen panel(s) remain visually integrated within the screen door frame and maintain a clean, finished appearance, avoiding the look of an externally mounted or temporary add-on.

1. An integrated magnetic screen system for a sliding screen door frame, comprising: a mesh screen comprising at least one vertical cut region and at least one horizontal bottom cut region; a pair of vertical magnetic strips disposed along opposing vertical inner edges of the vertical cut region, configured to enable automatic resealing of the mesh screen after passage; a screen door frame into which the mesh screen is secured, wherein the screen door is configured to slide within an adjacent glass door frame; at least one upper cut region formed near a top portion of the mesh screen, the upper cut region comprising a V-shaped, U-shaped, trapezoidal, or linear geometry and intersected by a horizontal bridge extending between opposing interior edges of the upper cut region; and one or more magnetic strips positioned along seams of the upper cut region and/or across the horizontal bridge.

2. The system of claim 1, further comprising at least one bottom magnetic strip disposed along a lower edge of the mesh screen to enhance sealing against a door sill.

3. The system of claim 1, further comprising at least one vertical zipper positioned between the vertical magnetic strips to provide optional manual closure or reinforcement.

4. The system of claim 1, further comprising at least one bottom zipper disposed near the bottom edge of the mesh screen to enable manual closure of the lower portion.

5. The system of claim 1, wherein the mesh screen includes reinforced mesh corners located at one or both lower corners, the reinforced corners comprising layered mesh, sewn synthetic fabric, polymer patches, or other strain-resistant materials.

6. The system of claim 1, wherein the magnetic screen system is integrated into the sliding screen door frame as a factory-built component.

7. The system of claim 1, wherein the magnetic screen system is provided as a retrofit kit configured to replace or upgrade an existing sliding screen door.

8. The system of claim 1, wherein the mesh screen permits hands-free passage and automatically returns to a closed configuration.

9. The system of claim 1, wherein the magnetic screen system operates without impeding the sliding operation of the adjacent glass door.

10. The system of claim 1, wherein the mesh screen comprises multiple segments joined at vertical and horizontal seams.

11. The system of claim 1, wherein the horizontal bridge within the upper cut region is linear, arched, or angled.

12. The system of claim 1, wherein the horizontal bridge and upper cut region contribute to improved resealing and structural stability of the mesh screen.

13. The system of claim 1, wherein the screen door frame is configured to accommodate a standard 72-inch sliding door opening or a custom-sized opening.

14. The system of claim 1, wherein the vertical magnetic strips and magnetic strips along the upper cut region are embedded within or sewn onto the mesh screen.

15. The system of claim 1, wherein the mesh screen is composed of fiberglass, polyester, or another flexible, insect-resistant material.

16. The system of claim 1, further comprising one or more magnets or zippers positioned along the V-shaped upper cut region to enhance closure functionality.

17. The system of claim 1, wherein the mesh screen is visually continuous with the surrounding door frame to maintain an integrated, non-temporary appearance.

18. The system of claim 1, wherein the magnetic screen system is configured for use by pet owners or users requiring hand-free access.

19. The system of claim 1, wherein the mesh screen, including the optional upper cut region and horizontal bridge, provides a wider passage area than a traditional center-seam design.

20. The system of claim 1, wherein the horizontal bottom cut region is positioned above the bottom edge of the mesh screen to allow separation without detaching the screen from the frame.
